(19) United States
(12) Patent Application Publication
(10) Pub. No.: US 2013/0304937 A1
(43) Pub. Date: Nov. 14, 2013

(54) INFORMATION CENTRIC NETWORK SYSTEM INCLUDING NETWORK PATH COMPUTATION DEVICE, CONTENT REQUEST NODE, AND RELAY NODE AND METHOD OF COMPUTING NETWORK PATH USING INFORMATION CENTRIC NETWORK

(71) Applicant: ELECTRONICS AND TELECOMMUNICATIONS RESEARCH INSTITUTE, Daejeon-si (KR)

(72) Inventor: Byung-Joon LEE, Daejeon-si (KR)

(73) Assignee: Electronics and Telecommunications Research Institute, Daejeon-si (KR)

(21) Appl. No.: 13/759,464

(22) Filed: Feb. 5, 2013

(30) Foreign Application Priority Data
May 8, 2012 (KR) 10-2012-0048775

(51) Int. Cl. H04L 12/56

(52) U.S. Cl. CPC H04L 45/74
USPC 709/238

(57) ABSTRACT

An information centric network system and a method of computing a network path using the information centric network system. The network path computation device includes: a network path representation unit configured to represent a network path using a BF; and a network path computation unit configured to, in response to a request from a content request node, compute the network path from the content request node to a content provider node, and, in response to the network path representation unit representing the network path using the BF, transmit the BF to the content request node.

### CROSS REFERENCE TO RELATED APPLICATION

This application claims the benefit under 35 U.S.C. §119(a) of Korean Patent Application No. 10-2012-0048775, filed on May 8, 2012, the entire disclosure of which is incorporated herein by reference for all purposes.

### BACKGROUND

1. Field

The following description relates to an information centric network.

2. Description of the Related Art

Recently, research on a new architecture for the future Internet has been actively carried out, and one of prospective technologies is an information centric network (ICN) technology. In an ICN, instead of address-based communications, communications using values, such as identifier or name of content, which are irrelevant to addresses, take place. For example, in response to content with a particular name from a content requester, the network transmits corresponding content to the requester based on the name of content.

For the communications based on a content identifier or name, a process for transforming the name of content into a location of content is required, and a network function to perform this process is generally referred to as content routing. The content routing function allows a user to use content by transmitting a request packet from the user to an actual location of the content.

Generally, content routing is performed by a network device installed on a network, for example, a router. For example, in a content centric network (CCN), one of ICN technologies, routers exchange location information of content with one another according to routing protocols, calculate the shortest distance to particular content based on the exchanged information, transform the calculation result into forwarding information base (FIB), and transmits a content request packet from a user to the location of content using the FIB.

However, since the amount of content delivered over the network is larger than the amount of IP addresses, if content routing is performed based on the amount of information, such as FIB, which is stored in the router, the router needs to increase the amount of information to be stored for content routing. The more the amount of routing information is required for content routing, the larger memory size is required to be installed in the router. Because the memory used in storing the routing information has to allow fast access thereto, the memory is expensive and not easy to expand. Thus, there is a need for a technology to enable content routing without increasing the amount of routing information.

### SUMMARY

Accordingly, in one aspect, there is provided an information centric network system capable of implementing content routing without storing information required for content routing in a network device, such as a router, and a routing technology using the information centric network system.

In one general aspect, there is provided a network path computation device including: a network path representation unit configured to represent a network path using a Bloom filter (BF); and a network path computation unit configured to, in response to a request from a content request node, compute the network path from the content request node to a content provider node, and, in response to the network path representation unit representing the network path using the BF, transmit the BF to the content request node.

In another general aspect, there is provide a content request node including: a network path request unit configured to request a network path computation device to computed a network path from the content request node, itself, to a content provider node and receive a BF representing the network path from the network path computation device; and a content packet transmission unit configured to transmit a content request packet to the content provider node, using the BF received from the network path computation device, through the computed network path, and receive a content response packet from the content provider node through the computed network path.

The content packet transmission unit may be configured to transmit the content request packet including the BF to the content provider node and receive the content response packet including the same BF from the content provider node.

The content packet transmission unit may be configured to transmit the content response packet including the same BF as a BF included in the content request packet and thus a network transmission path from the content provider node to the content request node becomes identical with a network transmission path from the content request node to the content provider node.

The content packet transmission unit may be configured to transmit the content request packet with the BF inserted into its header and receive the content response packet with the BF inserted into its header.

In yet another general aspect, there is provided a relay node including: a BF check unit configured to, in response to receiving a content request packet or a content response packet including a BF from a content request node, check identifiers of all neighboring nodes and confirm whether each identifier is present in the BF; and a content packet relay unit configured to, in response to a result of confirmation from the BF check unit, relay the content request packet or the content response packet to all nodes of which identifiers are confirmed to be present in the BF.

The BF check unit may be configured to check whether the BF includes a predetermined identifier, and the content packet relay unit is configured to transmit the content request packet including the BF to a node with the predetermined identifier if the BF includes the predetermined identifier.

In another general aspect, there is provided a method of a network computation device computing a network path, the method including: in response to a request from a content request node, computing a network path from the content request node to a content provider node; representing the computed network path using a BF; and transmitting the BF representing the computed network path to the content provider node.

Other features and aspects will be apparent from the following detailed description, the drawings, and the claims.

### BRIEF DESCRIPTION OF THE DRAWINGS

FIG. 1 is a diagram illustrating an overall configuration of an information centric network (ICN) according to an exemplary embodiment of the present invention.

FIG. 2 is a diagram illustrating in detail a configured of the network path computation device shown in FIG. 1.

FIG. 3 is a diagram illustrating in detail a configuration of the content request node.

FIG. 4 is a diagram illustrating in detail the relay node of FIG. 1.

FIG. 5 is a diagram illustrating an example of a process flow in an ICN according to an exemplary embodiment of the present invention.

FIG. 6 is a flowchart illustrating a method of a network path computation device computing a network path according to an exemplary embodiment of the present invention.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

The following detailed description relates to an information centric network (ICN) system structure, in which communication is performed using a value, such as content identifier or name, which is irrelevant to an address. For example, in response to a request for content with a particular name, a network transmits corresponding content to a content requester. For such communication, content routing is required to transform a name of content into a location of content. Generally, a network device, such as a router, performs content routing. However, according to the present invention, a network path computation device that is separately provided in an ICN performs content routing, instead of the network device such as a router. Hereinafter, a system structure suitable to provide content routing using a network path computation device according to exemplary embodiments of the present invention will be described with reference to the accompanying drawings.

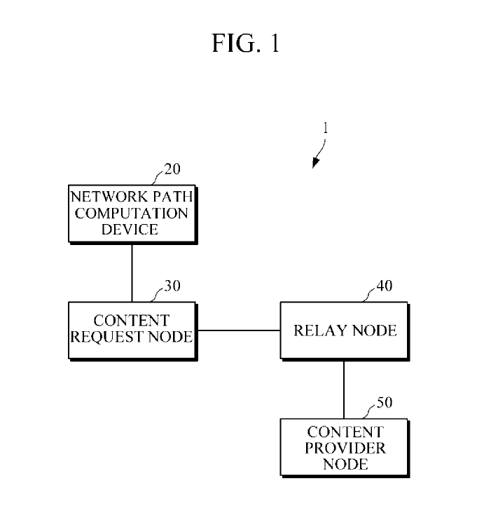

FIG. 1 is a diagram illustrating an overall configuration of an information centric network (ICN) according to an exemplary embodiment of the present invention. Referring to FIG. 1, the ICN 1 includes a network path computation device 20 and a plurality of nodes. The plurality of nodes may include a content request node 30, a relay node 40, and a content provider node 50.

The plurality of nodes, including the content request node 30, the relay node 40, and the content provider node 50, are network devices to provide, request and repeat content or to perform communication for content provision. The plurality of nodes may include, for example, a router, an access point (AP), a repeater, a relaying unit, and a bridge. However, the types of the nodes are not limited to the above and the nodes may include other types of network devices.

More specifically, the content request node 20 is a network device to request predetermined content, and the content provider node 50 is a network device to provide content. The relay node 40 is a network device to relay data communication between the content request node 30 and the content provider node 50.

The network path computation device 20 may be provided separately from the network devices including the nodes 30, 40, and 50, compute a network transmission path from the content request node 30 to the content provider node 50 in response to a request from the content request node 30, and provide the result of computation of path to the content request node 30. For example, the network path computation device 20 may inform the content request node 30 of the nodes that a content request packet from the content request node 30 has to pass through so as to obtain content from the content provider node 50.

The network path computation device 20 uses a Bloom filter (BF) to represent a network path. The BF, conceived by Burton Howard Bloom in 1970, is a probabilistic data structure that is used to test whether an element belongs to a set. With respect to a query about whether an element is a member of a set, a false positive result is possible (i.e., the BF reports that the element belongs to the set when it does not), but a false negative result is not possible (i.e., the BF never reports that the element does not belong to the set when it does). The probability of false positive results is greater than zero, and in this perspective, the BF is perceived as a probability data structure.

In the exemplary embodiments of the present invention, herein, the BF is used to represent a network path. A network path consists of a plurality of nodes. Each node is s assigned unique identifier, which may be an Internet protocol (IP) address of the node. A set of identifiers of all nodes included in one network path is represented using a BF. For example, if a network path includes three routers with addresses of 10.0.0.1, 10.0.0.2 and 10.0.0.3, the network path may be represented by a BF set {10.0.0.1, 10.0.0.2, 10.0.0.3}. Since the BF is a data structure that is possible to report false positive results, there is a potential for a false positive in response to a query about whether a particular router belongs to a path. For instance, with respect to a router with an address of 10.0.0.4, which does not belong to the above example BF set, the probability of a false positive result being acquired is greater than zero.

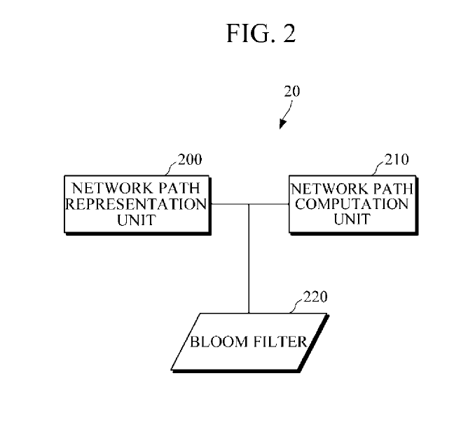

FIG. 2 is a diagram illustrating in detail a configured of the network path computation device shown in FIG. 1. Referring to FIGS. 1 and 2, the network path computation device 20 includes a network path representation unit 200 and a network path computation unit 210.

The network path representation unit 200 represents a network path using a BF 220.

In response to a request from the content request node 30, the network path computation unit 210 computes a network path from the content request node 30 to the content provider node 50. Then, in response to the network path representation unit 200 representing the computed network path using the BF 220, the network path computation unit 210 transmits the BF 220 to the content request node 30. The BF 220 is a data structure that represents a set of identifiers of all nodes on the network path and is used to test whether an element is a member of the set of identifiers. A probability of the BF 220 reporting of a false positive that indicates a false presence of an element is greater than zero with respect to a query about whether the element belongs to a set.

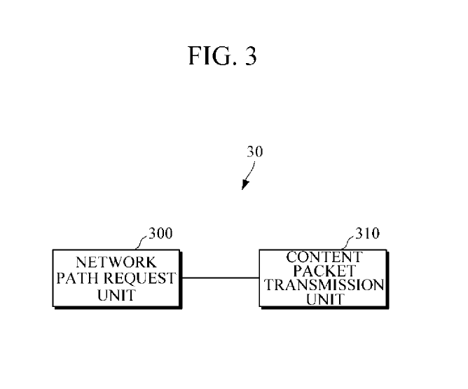

FIG. 3 is a diagram illustrating in detail a configuration of the content request node. Referring to FIGS. 1 and 3, the content request node 30 includes a network path request unit 300 and a content packet transmission unit 310.

The network path request unit 300 requests the network path computation device 20 to provide a network path from the content request node 30, itself, to the content provider node 50. Then, the network path request unit 300 receives the BF that represents the network path from the network path computation device 20.

The content packet transmission unit 310 transmits a content request packet to the content provider node 50, using the BF received from the network path request unit 300, through relaying of the relay node 40. Then, the content packet transmission unit 310 receives a content response packet from the content provider node 50 via the relay node 40.

In one example, the content packet transmission unit 310 transmits a content request packet including the BF to the content provider node 50, and receives the content response packet including the BF from the content provider node 50. The BF included in the content response packet may be the same as the BF included in the content request packet. In this case, the network path from the content response node 50 to the content request node 30 becomes the same as the network path from the content request node 30 to the content provider node 50. When the same network path is used to transmit the content request packet and the content response packet, it becomes easy to measure how much content delivery traffic is transmitted through the network path.

In one example, the content packet transmission unit 310 may insert the BF into the header of a content request packet before transmitting the packet, and receive a content response packet including a BF in its header.

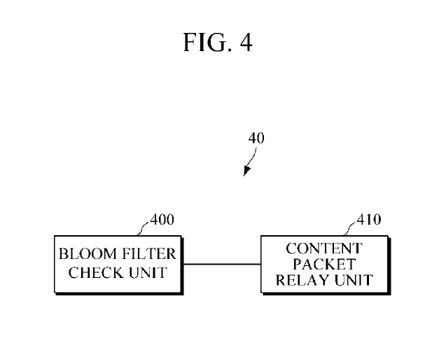

FIG. 4 is a diagram illustrating in detail the relay node of FIG. 1. Referring to FIGS. 1 and 4, the relay node 40 includes a BF check unit 400 and a content packet relay unit 410.

In response to receiving the content request packet including the BF, the filter verification unit 400 checks identifiers of all neighboring nodes to confirm whether there is an identifier belonging to the BF.

The content packet relay unit 410 relays the content request packet to all nodes whose identifiers have been confirmed to belong to the BF and transmits finally the content request packet to the content provider node 50. In addition, the content packet relay unit 410 relays the content response packet to the content request node 30.

In one example, the BF check unit 400 may check the BF to see whether a particular node identifier among the identifiers of the neighboring nodes belongs to the BF. If the particular identifier is confirmed to belong the BF, the content packet relay unit 410 transmits the content request packet to the corresponding node with the identifier.

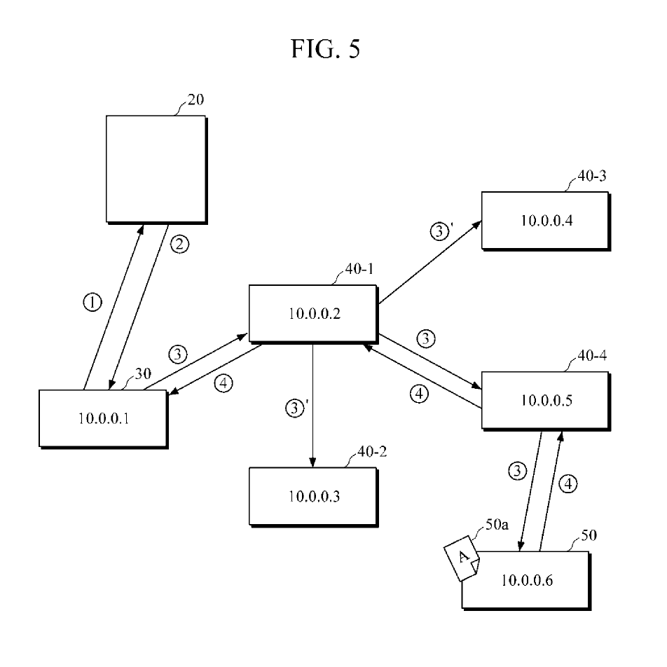

FIG. 5 is a diagram illustrating an example of a process flow in an information centric network (ICN) according to an exemplary embodiment of the present invention.

Reference numeral 20 in FIG. 5 denotes a network path computation device 20, reference numeral 30 denotes a content request node, and reference numerals 40-1 to 40-4 denote relay nodes, and reference numeral 50 denotes a content provider node.

The network path computation device 20 informs the content request node 30 of a network path consisting of nodes, through which a content request packet from the content request node 30 is transmitted to the content provider node 50 to request content. For example, referring to FIG. 5, if a router, as the content request node 30, with an identifier of 10.0.0.1 requests content A 50a (\textcircled{1}), the network path computation device 20 computes a path from the content request node 30, i.e., the router with an identifier of 10.0.0.1 to the content provider node 50 that is a router with an identifier of 10.0.0.6, and represents the computed network path as a BF set. In FIG. 5, the BF set is represented as {10.0.0.1, 10.0.0.2, 10.0.0.5, 10.0.0.6}. Thereafter, the network path computation device 20 returns the BF set to the content request node 30 with an identifier of 10.0.0.1 (\textcircled{2}).

The router with an identifier of 10.0.0.1, as the content request node 30, receiving the BF set from the network path computation device 20, transmits the content request packet to the content provider node 50 via relay nodes (\textcircled{3}). In this example, the content request node 30 may add the BF set to the header of the content request packet.

The relay nodes 40-1, 40-2, 40-3, and 40-4 that relay the content request packet transmits the packet according to the following procedures. First, the relay nodes check IP addresses of each of all neighboring nodes, except for the content request node 30, and confirm whether each IP address belongs to the BF set. If it is confirmed that the IP address is present in the BF set, the relay nodes transmit the content request packet to the node with the IP address (\textcircled{3}). The relay nodes 40-1, 40-2, 40-3, and 40-4 repeat the above process for all neighboring nodes. During the above operations using the BF set, a packet may be transmitted to a wrong node due to the false positive result from the BF (\textcircled{3}′). For example, in FIG. 5, the content request packet is transmitted to a wrong router 40-3 with an identifier of 10.0.0.4. However, the possibility of such occurrence is low and the request packet delivered to a wrong node cannot find the subsequent node to be transmitted and is thereby more likely to be discarded. Thus, such wrong transmission may not be substantially problematic. Moreover, if a loop prevention mechanism that checks a received packet is the same with the packet that had been already forwarded within a very short period, it is possible to suppress the wrong transmission effectively.

Finally, when the content request packet reaches the router, as the content provider node 50, with an identifier of 10.0.0.6, through the relay nodes 40-1 and 40-4, the content provider node 50 creates a content response packet and transmits it to the content request node 30. The content response packet may include the intact BF set that is inserted into the content request packet, and be transmitted to the content request node 30. Then, the content response packet is enabled to be transmitted through the same network path as the content request path (\textcircled{4}). Like the content request packet, there is a possibility of the content response packet being transmitted to a wrong node due to a false positive result. However, as mentioned above, the content response packet transmitted to a wrong node cannot find the subsequent node to be transmitted and thus is more likely to be discarded. Thus, such occurrence may not be substantially problematic. It is also possible to use the same loop prevention mechanism described above.

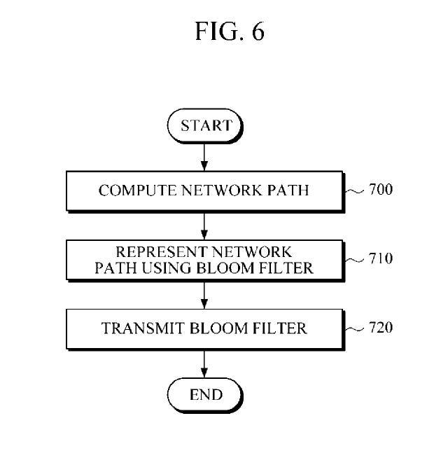

FIG. 6 is a flowchart illustrating a method of a network path computation device computing a network path according to an exemplary embodiment of the present invention. Referring to FIG. 6 in conjunction with FIG. 1, in response to a request from the content request node 30, the network path computation device 20 computes a network path from the content request node 30 to the content provider node 50 in operation 700. Then, the network path computation device 20 represents the computed network path using a BF in operation 710, and transmits the BF to the content request node 30 in operation 720.

In response to receiving the BF from the network path computation device 20, the content request node 30 transmits a content request packet to the content provider node 50 using the BF through the relay node 40. In response to receiving the content request packet, the content provider node 50 creates a content response packet, and transmits the created content response packet to the content request node 30 via the content relay node 40.

As described above, in an information centric network, a network path is computed by a network path computation device, the computed path is represented using a BF, and a content request packet including the BF and a content response packet including the same BF are transmitted through the computed path, so that it is possible to control the same network path to be used for transmitting both the content request packet and the content response packet.

In addition, since the network path is computed using the independent network path computation device, a node transmitting content does not need to separately store content routing information such as a forwarding information base (FIB), thereby resulting in the reduction of memory requirement. Hence, it is possible to easily achieve scalability in an information centric network in terms of network size.

Moreover, by using a BF, it is possible to use the same network path to transmit a content request packet and a content response packet, and as a result the amount of content delivery traffic transmitted through the network path can be easily measured. Additionally, although there may be a low possibility of a packet being transmitted to a wrong node due to a false positive result from the BF, it may be anticipated that the content delivery traffic flow is restricted to nodes around a corresponding path.

Furthermore, since by using the network path computation device, it is possible to control a network path for transmitting a content request packet and a content response packet, it is easy to perform traffic engineering by which traffic is managed and controlled depending on a network status.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A network path computation device comprising:
a network path representation unit configured to represent a network path using a Bloom filter (BF); and
a network path computation unit configured to, in response to a request from a content request node, compute the network path from the content request node to a content provider node, and, in response to the network path representation unit representing the network path using the BF, transmit the BF to the content request node.

2. The network path computation device of claim 1, wherein the BF is a data structure that represents a set of identifiers of all nodes on the network path and is used to test whether an element is a member of the set of identifiers.

3. A content request node comprising:
a network path request unit configured to request a network path computation device to computed a network path from the content request node, itself, to a content provider node and receive a BF representing the network path from the network path computation device; and
a content packet transmission unit configured to transmit a content request packet to the content provider node, using the BF received from the network path computation device, through the computed network path, and receive a content response packet from the content provider node through the computed network path.

4. The content request node of claim 3, wherein the content packet transmission unit is configured to transmit the content request packet including the BF to the content provider node and receive the content response packet including the same BF from the content provider node.

5. The content request node of claim 4, wherein the content packet transmission unit is configured to transmit the content response packet including the same BF as a BF included in the content request packet and thus a network transmission path from the content provider node to the content request node becomes identical with a network transmission path from the content request node to the content provider node.

6. The content request node of claim 4, wherein the content packet transmission unit is configured to transmit the content request packet with the BF inserted into its header and receive the content response packet with the BF inserted into its header.

7. A relay node comprising:
a BF check unit configured to, in response to receiving a content request packet including a BF from a content request node, check identifiers of all neighboring nodes and confirm whether each identifier is present in the BF; and
a content packet relay unit configured to, in response to a result of confirmation from the BF check unit, relay the content request packet to all nodes of which identifiers are confirmed to be present in the BF, transmit finally the content request packet to a content provider node, and relay a content response packet from the content provider node.

8. The relay node of claim 7, wherein the BF check unit is configured to check whether the BF includes a predetermined identifier, and the content packet relay unit is configured to transmit the content request packet including the BF to a node with the predetermined identifier if the BF includes the predetermined identifier.
